(19) United States
(12) Patent Application Publication
(10) Pub. No.: US 2016/0292650 A1
(43) Pub. Date: Oct. 6, 2016

(54) Block Level Origin Based Workforce Logistics System

(71) Applicants: Reginald "Sonny" Henry Smith, III, New Orleans, LA (US); Brendan Minard, New Orleans, LA (US)

(72) Inventors: Reginald "Sonny" Henry Smith, III, New Orleans, LA (US); Brendan Minard, New Orleans, LA (US)

(21) Appl. No.: 14/963,237

(22) Filed: Dec. 8, 2015

Related U.S. Application Data
(60) Provisional application No. 62/089,015, filed on Dec. 8, 2014.

(51) Int. Cl. G06Q 10/10

(52) U.S. Cl. CPC G06Q 10/1095

(57) ABSTRACT

A system is provided that enables users to manage workforce schedules and logistics. A block-level system interface may be provided on a personal interface device of a user in electronic communication with other users through a communication network which allows users to schedule events according to scheduling availability and resources based upon user input, data restrictions and filters synchronized with a calendar database. A unique service event hopper enables users to view and select available work events matched with the user's input attributes. The visual interface allows for dragging and dropping of work events, for resource allocation and constraints, enabling prevention of the scheduling of events that conflict with availability and capabilities of users.

### CROSS-REFERENCE TO RELATED APPLICATION

This application claims the benefit of priority of U.S. Provisional Application No. 62/089,015 filed November Dec. 8, 2014, of which all of the contents are hereby incorporated by reference.

### FIELD OF INVENTION

In present invention relates generally to calendaring systems and methods. More specifically, the present invention relates to systems that allow users to schedule events according to scheduling availability and resources.

### BACKGROUND

The ability to tie into business infrastructure for mobile employees has increased the productivity for both employees and businesses. Many of the advancements in business infrastructure productivity are rooted in a focus on the obvious communication staples such as email and chat. Both lack structure and organization. Others have evolved to share enterprise level information, but have a heavy interface focus on remote collaboration or sales and acquisition.

One area of business infrastructure productivity that has lacked significant advancement in light of improved mobile technology has been with scheduling logistics. The more variable the work and the larger the team is, the more work it takes for a supervisor to organize the field work on a daily basis to say nothing of reacting to unforeseen delays that require reallocation of resources or field employees to cover the new gaps in resources.

Some well-funded enterprises deploy complex, expensive software to overcome such challenges. But these enterprise software solutions require constant maintenance and tuning to enable them to make the requisite logistical decisions. Small businesses, on the other hand, such as those in the pet care industry, likely lack affordable alternatives to these expensive enterprise logistics tools and, as a result, often rely on the constant evaluation and entry of data into shared calendars that are ill-equipped to express the work in a meaningful manner, to both the supervisor and the field employee.

### SUMMARY

A Block-level Origin-based Workforce Logistics System (BOWLS) and methods are disclosed which supports supervisors in organizing daily mobile workloads and schedules by providing a variable-size interface for them. BOWLS enables users to see daily work distributed across their workforce with visual cues and constraints. Representing larger real-world elements that they would otherwise require the reference of disparate information systems in the process of their regular evaluation and monitoring. BOWLS virtually eliminates the need for finely-tuned intelligence software and makes the combined effort more efficient and accessible to smaller businesses that need mobile workforce management.

BOWLS is a novel approach in logistical scheduling allowing for incidental variance within a dynamic environment by partitioning time and allowing for flexibility. Travelling Salesman Problem (TSP), the foundation for most logistics systems, is a mathematical problem in which one tries to find the shortest route through a series of points while only passing through each point once. The BOWLS system compartmentalizes incidentals as well as service events and controls for time-loss. For example, a dog walker's schedule includes visits to multiple locations and must take into consideration likely delays and down periods involving traffic, weather and breaks within a. working day. Furthermore, the dog walker has to account for unforeseen circumstances that may include cleaning up messes, chasing after lost dogs or an alarm accidentally going off. These incidents are not normally accounted for in the TSP and therefore have limited capacity to measure lost time. BOWLS accounts for these changes and provides a sliding timetable making it easier for a dog walker/employee to work more efficiently and effectively within the allotted workday.

BOWLS includes information relevant to each on-location service within a schedule. Embodiments include visual cues to simplify and consolidate the nature of the on-location services and schedule into a single interface. This abstraction supports the user beginning with resource allocation onward through a change management process. Elements conveyed within BOWLS are tied to parameters stored within a database, evaluated by an application engine, and rendered by a human interface device as needed by the user.

### BRIEF DESCRIPTION OF THE DRAWINGS

FIG. 1 shows components of a system for managing deployable resources, according to an exemplary system embodiment.

FIG. 2 shows an exemplary user interface for managing, updating, and using a system for managing deployable resources.

FIG. 3 shows an exemplary user interface for managing, updating, and using a system for managing deployable resources.

FIG. 4 shows an exemplary user for managing, updating, and using a system for managing deployable resources.

FIG. 5 is a diagram showing an architecture of a system for managing deployable resources, according to an exemplary system embodiment.

APPENDIX A includes several attachments pertinent to this application.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting, the invention. Numerous specific details are described to provide a thorough understanding of various embodiments of the present invention. However, in certain instances, well-known or conventional details are not described in order to provide a concise discussion of embodiments of the present inventions.

Described herein are systems and methods for automatically scheduling deployable resources. BOWLS is designed around the core concept of matching a time period with a resource. Like many existing logistics systems, a resource's time is a limited function within a time period. In BOWLS, the Time Table, a sequence of time, is partitioned into Time Periods which are defined units of time within the Time Table. A Time Block is a conceptual container at the intersection of a Time Period and a particular resource. Time Blocks are empty initially and constrained within the Time Period. An Event is any activity that the user wishes to track and, conceptually, occupies space within a Time Block, Time Blocks can he filled with various types of Events such that the Resource has a non-ordinal relationship with the particular Event within the Time Period of the particular Time Table.

In a preferred embodiment, a system is provided for tracking and calendaring aspects of workforce deployment, and/or other deployable resources, by automatically and adaptably scheduling commitments and assignments for employees or resources, based on multiple factors affecting deployment decisions such as: date, time, conflicts, travel distance, workforce skills. For example, in some embodiments, the system may be implemented for effectively and efficiently scheduling dog-walking services. There are, however, many other advantageous implementations for a system capable of automatically and adaptably deploying workforce services and resources to customers, such as: utility service activation, home repair, auto repair, tutoring, direct store delivery, and child care among others.

In a preferred embodiment, the system automatically and adaptably schedules events based upon a number of factors and user inputs. In some embodiments, users may select, or otherwise input, the factors used by the system to suit a particular business or industry. As an example, in some embodiments, the factors driving the automated processes may be adapted to suit the principles of the dog-walking and pet care industry, and may include factors such as logistics, flexibility, employee operation, and employee availability.

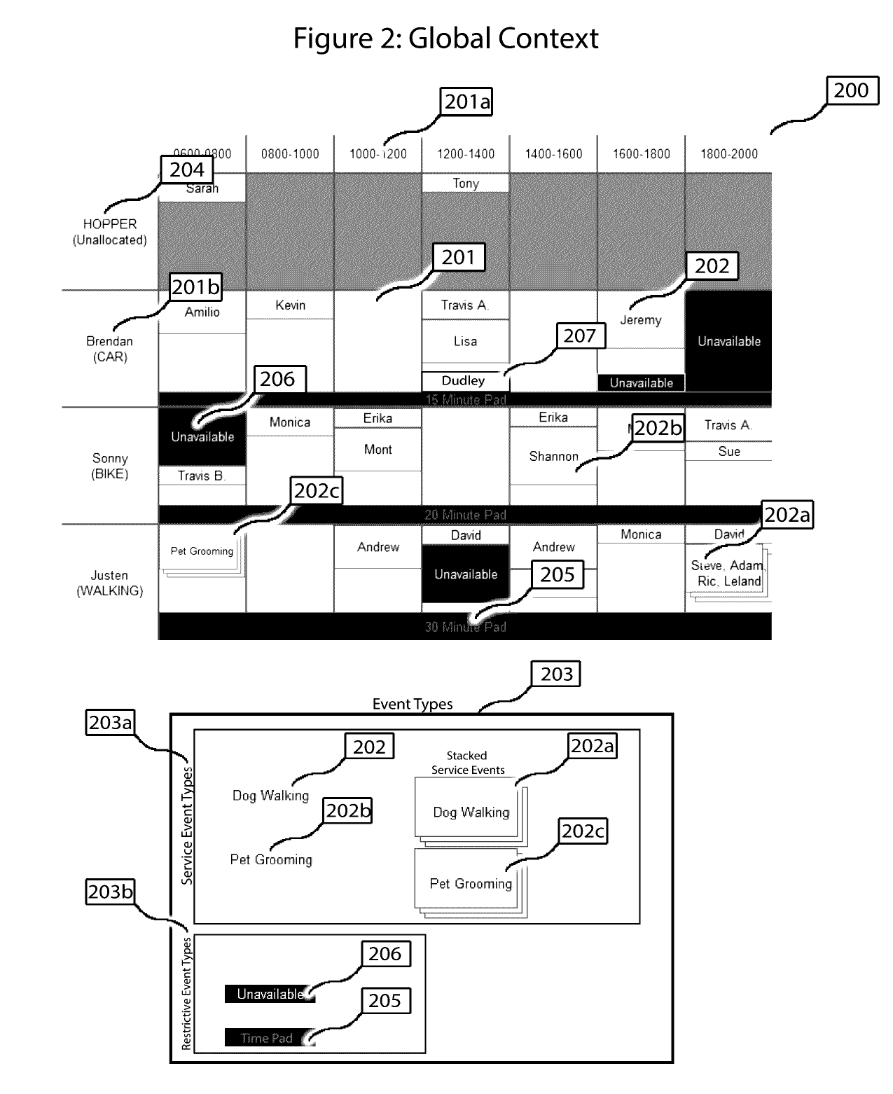

In some embodiments, the system may utilize other logistical factors for determining automated deployment scheduling. These other logistical factors may also be received, managed, and updated by the system. Non-limiting examples of logistical factors may include the time at which Events are scheduled, location of Events, anticipated duration of Events, and classification of the Event, among others. As an example of adapting deployment schedules based on logistics, the timing of Events may remain flexible within a Time Period (In FIGS. 2, 3 and 4, Time Periods appear in two hour increments, but users may elect any sized Time Period pursuant to their needs) to allow users to cluster work and services within a geographical proximity, such as a neighborhood, city, zip code, or any other customized metric aligned to the particular domain of work. The system may automatically update which deployable resources (e.g., employees, vehicles, tools) are scheduled for a given time, utilizing the various factors and processes described herein. In some cases, not all resources operate in the same way. For example, employees may require different modes of transportation to perform a specific task, and thus require the system to determine an employee's availability based on transit times. As another example, a user's tools or resources may require maintenance, which requires that they be unavailable for a period of time. The system may automatically determine and schedule the availability of such tools or resources based on automatically or manually inputted Time Padding, according to the maintenance being performed. In some embodiments, Time Padding is a generic buffer of time which represents periods of time between Events. The system may further automatically or manually adapt to updates to resource's availability, a client's availability, or a supervisor's needs. Automated and manual processes performed by the system may quickly capture such updates, and update the scheduled resources accordingly. The system may then automatically or periodically distribute, or push, such updates to devices associated with a company's work group.

### System Components

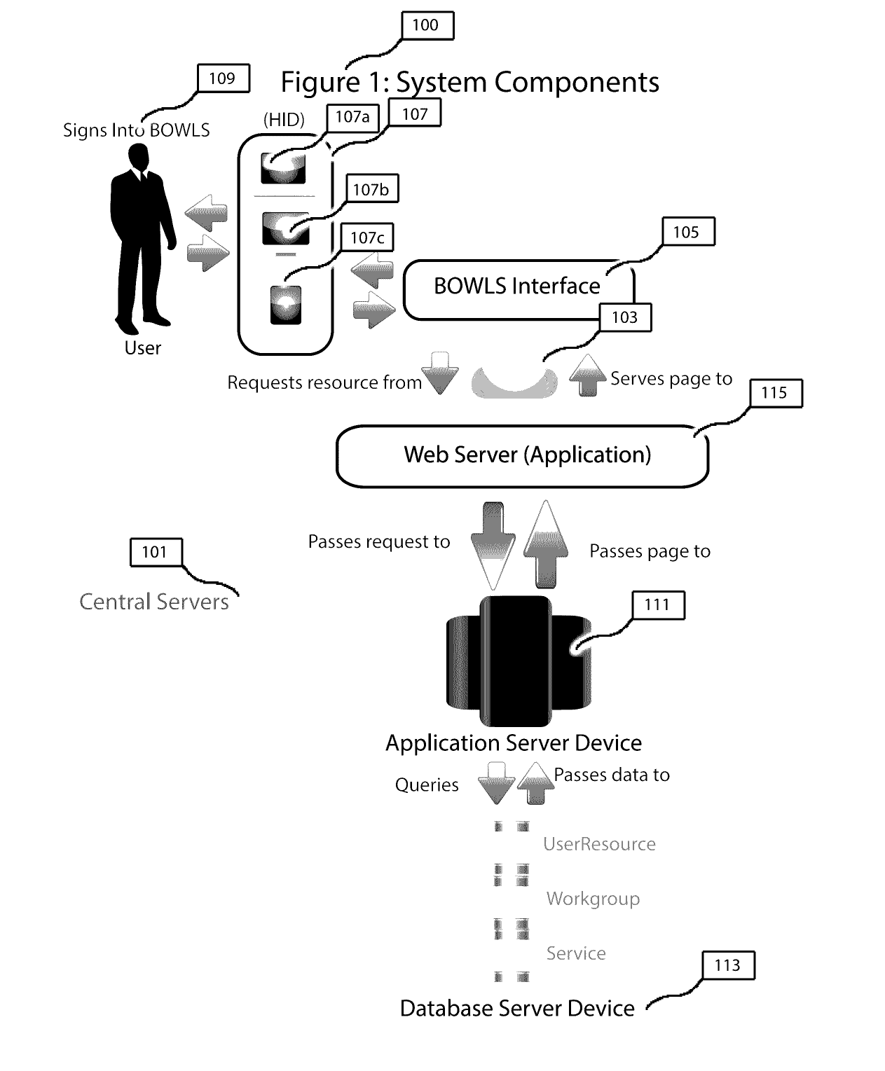

FIG. 1 shows components of a system 100 for managing deployable resources, according to an exemplary embodiment. The system 100 may comprise one or more central servers 101, a network 103, a system interface 105. Human Interface Devices (HIDs) 107, and users 109. The central servers 101 may be communicatively coupled with HIDs 107 over a network 103. The network may comprise any suitable hardware and software components capable of hosting communications between computing devices of the system 100. Communications between the central servers 101 and the HIDs 107 may utilize a system interface 105 comprising one or more application programmable interfaces (APIs) allowing for compatible data exchanges between the computing devices of the system 100.

Central servers 101 may comprise one or more computing devices that host software modules performing the various tasks described herein. Although described and shown in FIG. 1 as residing on separate computing devices, it should be appreciated that each of the software modules and devices of the central servers 101 may reside, in some embodiments, on the same computing device, or may be distributed across multiple computing devices, i.e., a distributed computing architecture. The central servers 101 may comprise an Application Server Device 111 and a Database Server Device 113.

An Application Server Device 111 may be any suitable computing device that comprises non-transitory machine-readable storage media storing software modules associated with the system 100 and a processor executing the software modules, such that the Application Server Device 111 is capable of performing the various tasks and processes described herein. The Application Server Device 111 may execute a validator module for validating Service Events stored in the Database Server Device 113. The validator module may store and automatically reference validation constraints for the Service Events as defined in the business logic of the validator module. The Application Server Device 111 may further execute a replication tool for automatically updating the database and business logic received from HIDs 107. Additionally, Application Server Device 111 can contain Or connect to a web server 115.

A database as embodied by Database Server Device 113 preferably resides on any suitable computing device that comprises non-transitory machine-readable memory storing data associated with the system 100 and capable of being communicatively coupled to an Application Server Device 111. The Database Server Device 113 may store data for the Application Server Device 111 to evaluate records from which an Event is rendered on a HID 107. This includes, but is not limited to, a table containing a list of workers and/or resources along with their associated constraints (such as mode of transportation and supported job types), and a table of Events with a relation to a worker or resource from the worker/resource table.

A web server 115 may be any suitable computing device that comprises non-transitory machine-readable storage media storing software modules associated with the system 100 and a processor executing the software modules, such that the web server 115 is capable of performing, the various tasks and processes described herein. The web server 115 may provide HIDs 107 with user interfaces, such as the system interface that display scheduling and deployment operations based on the output of an Application Server Device 111.

A system interface 105 can be established, from an HID 107 such as a laptop 107a, a personal computer, 107b, a smartphone 107c, or similar device. A discrete underlying algorithm running, on the HID 107 may render a system interface 105, as provided by a web server 115. In some embodiments, an HID 107 may comprise non-transitory machine-readable memory that stores cached local copies of the numerous datasets originating from the Central Servers 101, thereby allowing the HID 107 to locally evaluate and convey information via the HID 107 to the user, without having to communicate with the Central Servers 101. In such embodiments, changes to appointments that occur as a result of updating data stored in the local cache of the HID 107, may be replicated to an Application Server Device 111, as needed, to be further validated across a wider spectrum of time, to trigger immediate alerts on the HID 107 for the user as well as other actions at future Time Periods, which remain an action at the Application Server Device 111.

### Exemplary Interfaces

The following description is of the logic and visual cues that may be found on a HID 107. The exemplary interface 105 can be broken down into as few as three (3) states of context: Global Type Context, Selected Service Event Context, and Reassignment Constraint Context.

The Global Type Context is a rendering of a Time Table with associated Resources, Time Blocks, and related Events on an HID. The Selected Service Event Context is a change in rendering from the Global Context that visually emphasizes specific qualities of a selected Event relative to all other events within a Time Table on an HID. The Reassignment Constraint Context is a change in rendering from the Selected Service Event Context that visually emphasizes restrictions and limitations to a selected Service Event's reassignment on an HID.

FIG. 2 is exemplary of Global Type Context. This global view conveys Event information such as appointment time, appointment type, and duration of appointment across the Time Table 200. A Time Block 201 may be an intersection of a Time Period 201a and a Resource 201b. In this example, the Time Period 201a is in two hour increments. Time Periods 201a may be comprised of any unit of time (e.g., minutes, hours, days) as a lesser measure of the Time Table 200. The Time Block 201 appears empty when no event has been allocated to the Time Block 201. Non-ordinal events occupy the empty space inside a Time Block 201. Events represent records of appointments within the database on Database Server Device 113. Multiple Event Types 203 may exist and may be uniquely described by their appearance in the HID 107 as well as by their relation to established business logic and algorithms. Common characteristics of all Event Types 203 are that the portion of time within the Time Block 201 dedicated to an Event Type 203 corresponds proportionally to the space visually represented within the lime Block 201 for the Event 203.

Events may be broken down into one or more Event Types 203. One possible Event Type 203 is a Service Event 203a which can be colored or otherwise identified to designate the type of work associated with the Service Events 202, 202b. Service Events 203a can represent appointments or scheduled work for an employee or resource. One or more Service Events 203a may be placed into a Time Block 201 to indicate that events or services are scheduled to occur or be completed within a Time Period 201a.

Automated processes may review Service Events 202 to automatically identify scheduling conflicts, such as assigning a Service Event 203a beyond the expiration of a Time Block 201. For example, in some embodiments, a Time Block 201 may prohibit Service Events 202 from overflowing from one Time Block 201 into another Time Block. And, in sonic embodiments, automated processes may prevent users from overfilling a Time Block 201, i.e., scheduling; too many employees or scheduling a Service Event 203a that is too long.

Service Events 203a can be moved around, as needed, between Time Periods 201a and employees or resources 201b as represented by Time Blocks 201. Changes to Service Event Types 203a may change the related records within the database and one Event motion can be set to dynamically update another. For example, deleting a Dog Walking Service Event 202 from the interface, and thus the underlying database in Database Server Device 113, may result in automatically canceling the underlying appointment. Similarly, the dynamic association may prohibit users from deleting the Dog Walking Service Event 202 without also canceling the underlying appointment in the system records. As another example, the dynamic association between the interface rendering Service Event Types 203a and the scheduled appointment may result in automatic updates to underlying records or prohibit users from scheduling appointments inappropriately, such as when they would spa overflow into multiple Time Blocks 201. Optionally, Service Event Types 203a such as Dog Walking Service Event 202 can be prohibited from being moved to field employees and resources 201b who are restricted from being assigned to a type of work, and/or according to any other restrictions. For example, as shown in FIG. 2, a Resource 201b may only be assigned to groom animals, but may not walk them. Optionally, Service Events 203a can be stacked to represent a field employee or resource fulfilling multiple Service Events 203a simultaneously, as shown as Stacked Service Event 202a, Stacked Service Events 202a can be allowed or restricted based on an algorithm that accounts for Service Event relationships among the various Service events including, but not limited to, proximity. In some iterations, Stacked Events can modify appointment duration to account for additional mobilization and demobilization of Resources from the Stacked Event 202a. In addition, through business logic, the Special Service Event 207 may be prioritized according to special time constraints input by the user such that they are locked to specific times within the Time Block 201.

Another possible Event Type 203 is the Restrictive Event Type 203b. In some iterations, Restrictive Event Types 2036 represent the time that has been identified as significant for decision-making purposes, but not considered part of the time allocated to a Service Event 203a. One example of a Restrictive Event Type 203b is the Unavailable Event 206 which represents reserved, nonworking time. Unavailable Event 206 may represent, for example, maintenance windows for took, lunch hours, daily breaks, off-hours, and vacations. Like Service Events Types 203a, Unavailable Events 206 are displayed as being proportional in length-of-time, relative to the size of the Time Block 201 in the Interface 200 and can support a change management process for entry and modification. Events 203 allocated to Time Blocks 201 can be organized logically to the preference of the user.

A Hopper 204 may be a queue for work that needs to be allocated to a field employee or Resource 201b, either because the work is new or the work conflicts with a Time Block 201 within which the work cannot fit. The Hopper 204 may be a holding area for appointments that have been committed to, but not yet allocated to a Time Block 201.

Time Padding 205 is a Restrictive Event Type 203b and represents a non-work buffer of time for travel and other incidental periods necessary between Service Events 202 within each Time Block 201. Time Padding 205 may be automatically or manually determined, and may be referenced when scheduling work events so that events may be grouped together in an efficient manner. Time Padding may be uniform for the Resource 201b or take on a variable form relative to the nature and quantity of the Service Events 203a within the Time Block 201. As an example in FIG. 2, modes of transportation are a factor and affect the amount of Time Padding 205 the supervisor allocates to complete the work within the block.

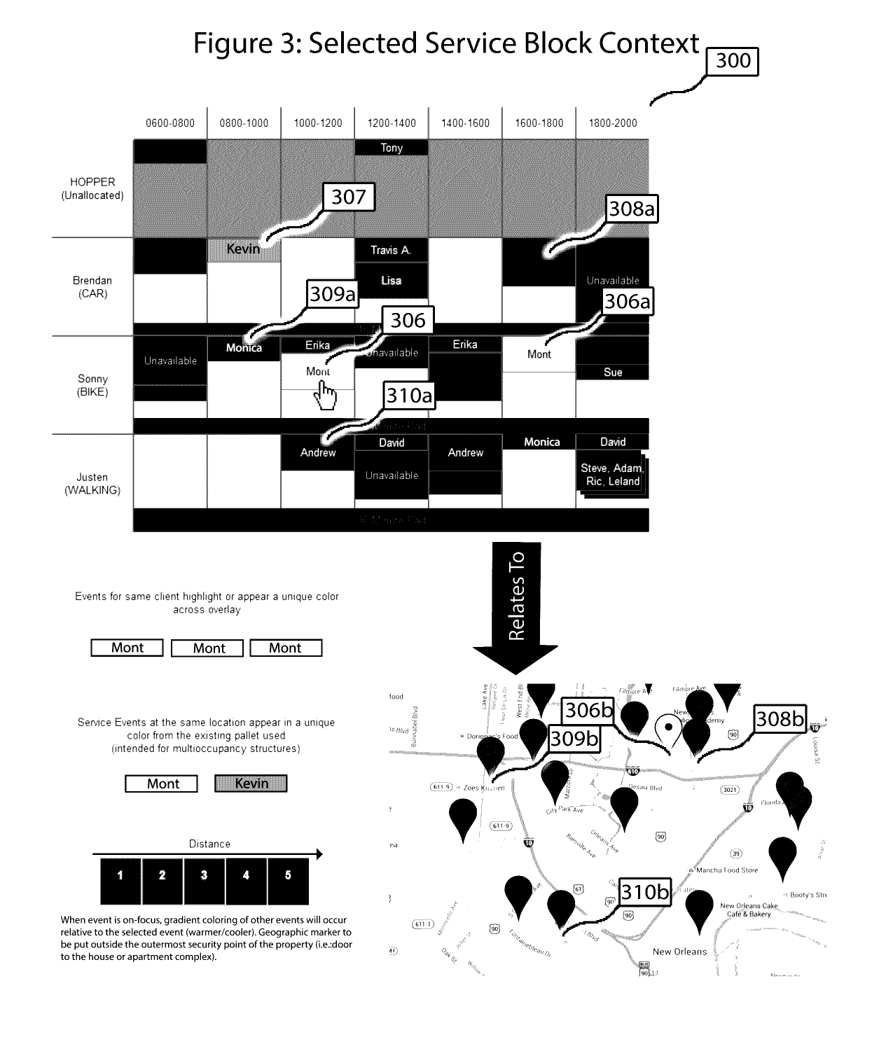

FIG. 3 shows an exemplary Time Table 300 displaying a Selected Service Block Context, Time Table 300 provides a further explanation of distance and time relative to location and Event duration. In some embodiments, this second context displayed on the Time Table 300 may be a selected Service Event 203a context. The Time Table 300 may build on the context of the Global Type Context, as exemplified by FIG. 2 by aggregating and conveying additional properties stored in database records of Service Events 203a. These additional properties may appear within the HID when a particular Service Event 203a such as Dog Walking Service Event 202 is selected by a user. Activation of the Selected Service Event Context of the Time Table 300 may automatically trigger a calculation process that compares the relative geographic location of neighboring Service Events 203a such as Dog Walking Service Event 202 to another Service Event 203a selected and referred to as Origin 306.

An Origin 306 is a special status of an Event. In FIG. 3, an Origin 306 is selected by the user 109 through the HID 107, The Origin 306 may influence the Time Table 300 look-and-feel, user experience, and various other display outputs, as derived from which Service Event 203a within the Time Table 300 receives the Origin 306 designation. A user 109 may input a selection indicating that a Service Event 306 is the Origin 306, which may result in changing the appearance of the Service Event 306 to an Origin 306, such as changing the color, to identify the user's 109 selection of the Service Event 306 for the Origin 306. In FIG. 3, Origin 306 is highlighted in yellow conveying that it is the Event of orientation for all other Events within the Time Table 300. A Related Service Event 306a may be within a view that is both tied to the same customer and at the same location. Beyond this example, it is possible to see multiple Service Events 306a, 307, 308, 309, 310 associated in similar fashion. Service Event 307 may represent a Service Event 203a that is scheduled to occur at the same geographic location as Origin, except the Service Event 307 is scheduled to be performed for a different client and is colored bright orange. Service Events 308a & 308b, Service Events 309a & 309b. and Service Events 310a & 310b represent the respective correlation between colors and distances from those particular Service Events 308a, 308b, 309a, 309b, 310a, 310b, relative to the Origin 306. in some implementations, the degree to which appearances of the particular Service Events 308a, 308b, 309a, 309b, 310a, 310b, such as the variance in the “warmth” of the color gradient, may be determined by the relative geographical distance from the Origin 306, by Time Padding, and/or by relative distance from every other event within the view of the Time Table 300, among other possible influences. Appearances of Service Events 306, 307, 308. 310, such as coloring, within the view of the Time Table 300 may be automatically reevaluated in response to receipt of a selection action by the user from an HID.

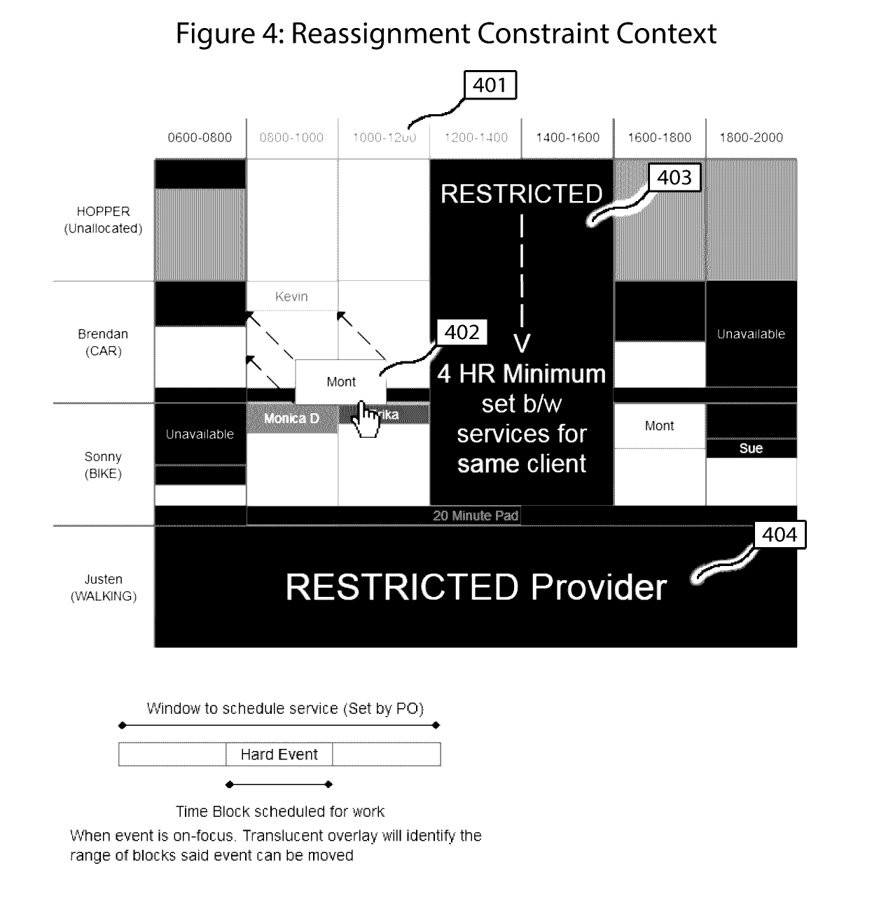

A third contextual change occurs when the user attempts to move a Service Event 402 within the interface on a HID. The Reassignment Constraint Context applies additional visual cues within the interface to convey the acceptable Time Blocks to which the Origin Service Event ma be moved. In FIG. 4 is an example of such an interface by which the context is switched when the user attempts to move the Origin Service Event 402 to a new location within the view on the HID. Acceptable Time Periods 401 are highlighted in yellow. In contrast, Time Blocks 201 ineligible for the work are covered by a darkened mask and will not allow the user to allocate the Service Event to them.

This includes Time Blocks 201 in which work may not be initiated, performed or concluded (expressed by Mask 403) as well as employees restricted from performing the work attached to a particular Service Event (expressed by Mask 404). Time Blocks into which an Event cannot temporally fit convey that the time needed to complete a task exceeds the time available within that Time Block. As such, the Event reverts to its original location.

In some embodiments, a user 109 manipulates the interface and populate Time Blocks 201 in a number of ways as described in the following examples. Referring to FIG. 3, the initial user 109 finds all Time Blocks 201 empty and all Service Events 203a are allocated to the Hopper Row 204. Since columns are the axis for Time Periods 201a, an unassigned Service Events 203a can be allocated to the Hopper 204 that is within the acceptable Window of Opportunity for doing the work according to the appointment. The Hopper 204 is as big as is needed to visually contain unassigned Events 203 and may not be represented the same way as Resource 201b Rows. The intent is to drive the priority for the supervisor and field employee to eliminate Events 203 from the Hopper 204 by properly assigning Events 203 to Time Blocks 201. As Events 203 are dragged out of the Hopper 204, the Reassignment Constraint Context appears.

When a user populates a Time Block 201 with Events 203 such as Service Events 203a, the user 109 may also choose to populate a recurring or repeating Service Event 203a in a similar or corresponding Time Block 201 in future Time Tables 200. If said Service Event 203a repeating into the future Time Tables 200 conflicts with a Resource's 201b future availability Time Block (such as a future Time Block 201 that is full), the Event 203 will reallocate to the Hopper Row 204 in the conflicting Time Period 201a and a message can be displayed identifying the conflict. The logic is that an established schedule should take precedence over any proposed changes. This also controls how users are precluded from making changes to committed future.

Time Blocks Blocks 201 beyond the visual range of the Time Period 201a in the HID 107. Preferably, when the conflicting Event 203 is assigned to a valid Time Block 201 with sufficient Resource 201b availability, the system will prompt the user to change this individual Event 203 or replicate the Event 203 properties within the same Time Block 201 in future Time Tables 200 within a range. The system automatically populates the date range with the beginning and end ranges of the conflict. The beginning and end of the range is abutted by Time Periods 201a where the Time Block 201 does not contain a conflict. On another embodiment, there is also an alternative “carryover” option that can be used in place of the end date of the conflict. Use of “carryover” changes all future dates, regardless of conflict, to the Time Block 201 selected in the current date. “Carryover” changes that encounter a future conflict will work the same as the original Time Block 201.

In one embodiment, one way to create an Unavailable Event 206, the user must select the empty part of a Time Block 201. The option to create the Unavailable Event 206 will appear for confirmation. Once the user confirms that they want to create the Unavailable Event 206, a prompt appears asking the user to confirm the duration of the Unavailable Event 206. Optionally, the User 109 can toggle to a set of options to specify a time range fur the Unavailable Event, Unavailable Events 206, like Service Events 203a, may be scheduled as repeating or recurring in future Time Tables 200.

When changes to Events 203 are made within the system, they are then validated and committed to the Central Servers 101 and a notification is can be sent to all devices that are able to view the specific Time Blocks 201 affected.

Events 203 are activities that can occupy a Resource's 201b available time.

A Hopper 204 is a conceptual container of all unallocated Events 203.

Users 109 are those both accept and input data into an HID 107.

Manager Users (also known as Supervisors) are those who can take direction as well as organize Events 203.

Time Period 201a is a unit of time into which a Time Table 200 can be subdivided.

Distance Gradient Module 502 assesses different grading functions to determine the relative distances of all Event 203 sites from an originating Event 203 Site.

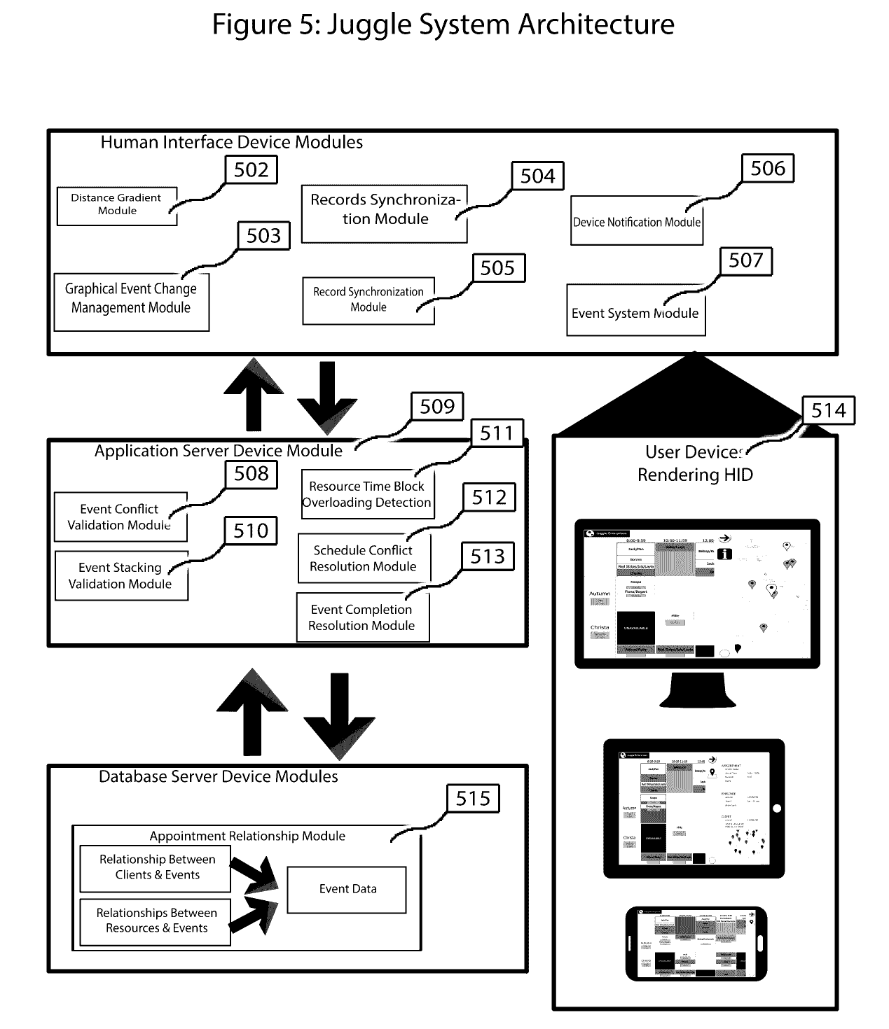

Referring to the human interfaces device 107 modules illustrated in FIG. 5, the Distance Gradient Module (DGM) 502 represents the algorithm by which BOWLS assesses the relative distance from an Origin Event 306 to all of the other events within the Time Table 200 support to render a relative. The DGM 502 can source data from several places including a device's global positioning system and location data related to a Service Event 203a that is stored within the Database Server Device 113. DGM 502 accepts higher-level lambda function determining distance gradient scaling criteria and applies them to all applicable Events 502 in relation to a Selected Event 306.

Graphical Event Change Management Module (GECM) 503 represents the algorithms by which an Event 203 is assessed for logistical constraints in the change management process for a particular Time Table 200. The GECM 503 renders visual cues that emphasize specific Time Blocks 201 that can accept the change of a Selected Event 306. Depending on implementation, GECM 503 can support both Supervisors and Resources 201b. Where constraints are exceeded. GECM 503 disallows completion of the change management and returns the Event 203 to its original state. Permissions for GECM 503 determine a User's 109 ability to see or modify data within the BOWLS Interface 105.

Record Synchronization Module 504 represents the algorithm by which an Event 203 validate through GECM 503 records to be modified on the HID 107 and replicate that change to the Central Servers 101 for verification. Manager initiated schedule change notification module informs Resource 201b of schedule updates. Allows Resources 201b to signal when an Event 203 has begun and ended so the Client or Supervisor can be notified.

Customer Event Interface Module 505 provides a mechanism for the User 109 of the HID 107 to view and update Event 203 information.

Device Notification Module 506 allows HIDs 107 to receive Event 203 status updates such as start, completion, and modification.

Event System Module 507 dispatches information about completed Events 203 to relevant external HIDs 107 via an HTTP-based External Service Bus.

Referring to the application server device modules illustrated in FIG. 5, Event Conflict Validation Module 508 represents an Application Server Device Module 509 that processes several algorithms. Event Stacking Matching Module 510 determines which Events 203 can be stacked (performed simultaneously by the same Resource 201b). Resource Time Block Overloading Detection Module 511 analyzes Resource 200 schedules and evaluates, if overloading occurs, Schedule Conflict Resolution Module 512 informs the User 109 and prompts a response to resolve it.

Event Completion Resolution Module 513 pushes notifications relative to the start of Event 203 and the end of Event 203 end to various User HIDs 514 as illustrated in FIG. 5.

Referring to the database server device modules illustrated in FIG. 5, Appointment Relationship Module 515 stores records of Users 109 such as Resources 201a, Clients, and Events 203 by establishing: a one-to-many relationship between a Clients and their Events 203 in addition to establishing a one-to-many relationships between each Resource 201a and their Events 203.

The invention claimed is:

1. A block-level system for scheduling events based upon user input and data restrictions synchronized with a calendar database, the system comprising:
a human interface device in electronic communication with a communication network of computer servers for storage and sharing of information, wherein:
the device is configured to receive an identification of a first user, a second user and a third user;
the device is further configured to receive event data of the second user, said event data including events requested by the second user and respective blocks of time for said events requested;
the device is further configured to receive attribute filters of the third user, said attribute filters including calendar availability information and user capability information, to determine blocks of time;
the device is further configured to visually display blocks of scheduled events if the event data of the second user is included in the attribute filters of the third user.

2. A computer-implemented method for sharing content comprising:
receiving an identification from a first user, a second user and a third user;
receiving event data of the second user, said event data including events requested by the second user and respective blocks of time for said events requested;
receiving attribute filters of the third user, said attribute filters including calendar availability information and user capability information, to determine and associate available blocks of time for said events requested;
receiving attribute filters of the third user, said attribute filters including calendar availability information and user capability information, to determine blocks of time;
visually displaying blocks of scheduled events if the event data of the second user is included in the attribute filters of the third user.
